(19) United States
(12) Patent Application Publication
(10) Pub. No.: US 2019/0323562 A1
(43) Pub. Date: Oct. 24, 2019

(54) ROTATIONALLY SYMMETRICAL HOLLOW BODY, AND METHOD FOR PRODUCING THE SAME

(71) Applicant: Schmidt Automotive GmbH, Westhausen-Lippach (DE)

(72) Inventor: Herbert SCHMIDT, Westhausen-Lippach (DE)

(21) Appl. No.: 16/310,094

(22) PCT Filed: May 29, 2017
(86) PCT No.: PCT/EP2017/062930

§ 371 Date: Dec. 14, 2018

(30) Foreign Application Priority Data
Jun. 17, 2016 (DE) 10 2016 111 128.7

(51) Int. Cl. F16D 1/08; F16C 3/02

(52) U.S. Cl. CPC F16D 1/0847; F16C 2226/10; F16C 3/02

(57) ABSTRACT

The invention relates to a rotationally symmetrical hollow body having a main body (18), and to a method for producing the same, having a cavity (12) which extends along a longitudinal axis (14) of the main body and which is delimited by an inner wall (17) of the main body, wherein at least one filling body (24) is inserted into the cavity, the longitudinal extent of which filling body in an axial direction with respect to the longitudinal axis of the main body is smaller than the length of the main body, and wherein the filling body is fixed in a fixing position relative to the main body by at least one clamping means which acts between the filling body and the main body, and a functional region (21) is formed in the main body by the filling body.

The invention relates to a rotationally symmetrical hollow body and a method for its production.

In various technical fields of application, in particular in engine construction, lightweight construction is at the forefront. With rotating components, such as drive shafts, camshafts or other shafts, for example, these are produced from a solid material. As a result, functional regions can be formed in a simple manner, for example by introducing bores, pins, springs or similar.

The use of rotationally symmetrical hollow bodies, such as hollow shafts or similar, for achieving the lightweight construction is generally known. However, here, up until now, the formation of functional regions is complicated or has not been successful. For example, when introducing a transverse pin into the hollow shaft to form the functional region in the hollow shaft, there is the problem that this transverse pin cannot maintain its position during a subsequent heat treatment or curing treatment.

The object of the invention is to propose a rotationally symmetrical hollow body and a method for its production, which, on the one hand, enables a lightweight construction method and, on the other hand, the formation of functional regions as with a solid shaft.

This object is solved by a rotationally symmetrical hollow body, in which at least one filling body is used in a cavity of a base body of the rotationally symmetrical hollow body, which extends along the longitudinal axis of the base body, wherein the longitudinal axis of the filling body is smaller than the longitudinal axis of the base body, and the filling body is fixed in relation to the base body in a fixing position by at least one clamp, such that the filling body forms a functional region for the rotationally symmetrical hollow body. This arrangement makes it possible that the filling body is only used in the region of the base body in which the functional region is to be present, and thus the filling body having the base body is similar to a solid cross-section or corresponds to a solid cross-section. The cavity in the base body extends adjacently thereto, such that a mass reduction is achieved. By positioning the filling body inside the hollow body and introducing at least one clamp, the functional region can be maintained even with subsequent processing, such as a heat or curing treatment, for example, or machining processing of the rotationally symmetrical hollow body.

The filling body preferably has an outer periphery having at least one contact surface, which corresponds at least sectionally to the contour of the inner wall of the cavity, and the corresponding outer periphery is formed smaller than the inner periphery. This makes it possible that the filling body can be inserted in a simple manner into the cavity of the base body and can be moved or shifted along this in an axial direction until it is arranged in a fixing position in which the functional region is to be formed after the introduction of the at least one clamp. Furthermore, further functions can be fulfilled by the contact surface which is formed at least sectionally on the outer periphery of the filling body. For example, there can be a simplified introduction into the hollow body, since functional surfaces can be formed between the contact surfaces for this purpose. Furthermore, further functions can be created by the regions between the contact surfaces, such as a choke point for a fluid, for example.

Furthermore, at least one contact surface of the filling body that is formed sectionally and forms the outer periphery is preferably measured with a transition fit or clearance fit in relation to the inner wall of the cavity. This enables, on one hand, a simple insertion of the filling body into the cavity of the base body and, on the other hand, this is achieved by a marginal deformation of the wall of the base body during a clamping with the filling body.

A further preferred embodiment of the invention provides that the clamp is formed between the filling body and the base body by at least one embossing point. As a result, the deformation acting on the cavity wall can be concentrated to as small a region as possible, preferably to a punctiform region, in order to still achieve a sufficient fixing of the filling body to the base body.

Advantageously, the at least one embossing point is formed with an embossing tool. Here, an embossing tool can be provided which acts radially on the base body from the outside. As a result of a plastic deformation of the wall of the base body, the clamp is formed with the filling body. A surface pressure is preferably formed between the inner wall of the base body and the at least one contact surface formed sectionally on the outer periphery of the filling body. This embossing stamp can have, for example, a cylindrical, spherical or conical embossing surface or similar.

In the region of the filling body in which the contour of the contact surface formed at least sectionally on the outer periphery corresponds to the inner periphery of the cavity, the at least one embossing point is introduced. As a result, with an only marginal plastic deformation of the base body, a planar pressure or clamping to the filling body is achieved, whereby the holding force acting on the filling body in the fixing position is increased.

Only one embossing point can be provided for fixing the filling body. Similarly, several embossing points can be provided in a radial plane in relation to the longitudinal axis of the base body. Furthermore, several embossing points spaced apart in relation to one another along the longitudinal axis of the hollow body and/or offset in relation to one another in a radial direction can also be introduced. Several embossing points can also be introduced in several radial planes spaced apart from one another.

The length of the filling body along the longitudinal axis of the base body is formed at least greater than the at least one embossing point extending in the longitudinal direction. The at least one contact surface is preferably formed to be equal to or greater than the embossing stamp in the axial direction and/or in the radial direction on the filling body. As a result, a high holding force and clamping force can be possible with a small flat extension of the embossing point.

Advantageously, the filling body has flattened portions or indentations in the radial direction between the contact surfaces formed at least sectionally on the outer periphery. Such flattened portions or indentations can make the media exchange and/or gas exchange possible on the inside between two adjacent hollow body portions. A choke point, for example, can also be formed by this flattened portion, if the hollow body is flowed through by a medium. Similarly, these indentations or flattened portions can also be holding surfaces for a gripping device for the introduction of the filling body.

The filling body is preferably formed from a solid material. This can be processed before or after the introduction into the cavity, such as the introduction of a through-bore.

Furthermore, the rotationally symmetrical hollow body has a base body having a cylindrical inner wall, the diameter of which is preferably the same across the entire length of the base body. As a result, several identical filling bodies at predetermined distances can be inserted into the cylindrical base body, in particular a shaft, in order to form functional regions as needed.

Furthermore, a flange is advantageously provided on a front face end of the base body, and the filling body is preferably integrally formed on the flange. This enables a component reduction, if a filling body is to be provided in the end region of the hollow body and, in this end region, a flange is also to be applied which has or receives a drive component, for example.

Furthermore, the object underlying the invention is lacuna by a method for producing a rotationally symmetrical hollow body having a base body, a cavity extending along the longitudinal axis thereof, in which a filling body is inserted into the cavity of the base body on a front face end of the base body; the filling body is then axially transferred into a fixing position along the longitudinal axis of the base body, and the filling body is fixed in the fixing position with a base body by a clamp in order to form a functional region. This method has the advantage that a rotationally symmetrical hollow body, which consists of a hollow base body, such as a tube, for example, a shaft or similar, has a low weight, yet is strengthened or filled in individual regions by the filling body, in order to form a functional region, as there is in a base body consisting of a solid material. However, the regions lying between the individual functional regions of a hollow body are only formed by the wall of the base body, said wall surrounding the inner cavity in lightweight construction. As a result, a weight-reduced rotationally symmetrical hollow body can be created, which comprises functional regions, as with a rotation body, made of a solid material. Such functional regions can, for example, serve for receiving a pin, spring-loaded balls or also for separating between two adjacent cavities.

To form the at least one functional region, a filling body is inserted into the base body, the outer periphery of which is formed by at least one sectionally formed contact surface, which corresponds to a contour of the inner wall of the cavity, wherein the outer periphery of the filling body is smaller than the periphery of the inner wall of the cavity. As a result, a simple insertion and shifting of the filling body takes place inside the cavity.

Preferably, the longitudinal extension of the filling body in the axial direction in relation to the longitudinal axis of the base body is smaller than the base body. In particular, the filling body is formed to be smaller than the length of the base body by a multiple. As a result, the mass of the rotationally symmetrical hollow body is considerably reduced in general, such that a substantially formed, solid cross-section or even a solid cross-section is provided virtually only in the functional region.

The clamp between the filling body and the wall of the base body is preferably formed by an embossing point, in particular an embossing point introduced radially from the outside. As a result, the clamp can be introduced on the outer periphery of the base body in only a small region in order to achieve a secure fixing of the filling body.

Advantageously, the embossing point is introduced by an embossing tool, which is supplied radially from the outside on the base body, wherein a wall section of the base body, which is opposite the filling body in the fixing position, is pressed radially inwards, such that the filling body is held in a clamped manner in the fixing position. The embossing point can cause an indent with respect to the peripheral surface on the outer peripheral surface of the base body. As a result of the introduction of the embossing point, a quick and secure fixing of the filling body in the hollow body can be obtained.

Advantageously, the embossing point is preferably introduced in the region in which the at least one sectionally formed contact surface on the outer periphery of the filling body corresponds to the contour of the inner wall of the base body. As a result, a sufficient positive engagement, in particular a surface pressure, is additionally achieved.

Preferably, two opposing embossing points are introduced. Preferably, two opposing contact surfaces are also provided on the outer periphery of the filling body, such that the opposing embossing points and the opposing contact surfaces are aligned along a fixing axis. This fixing axis can be several degrees offset with respect to a bore axis in the functional region, in particular in the filling body and the base body, wherein the bore in the filling body can already be introduced before the introduction into the base body or also after the fixing of the filling body in the base body. Preferably, the functional region extends in the filling body in which the contact surfaces are passed through and, if flattened portions are present, extends adjacently to the flattened portions.

A further alternative embodiment of the invention provides that several embossing points arranged to be distributed across the periphery are introduced. Only one embossing point can also suffice.

The filling body is preferably introduced into the cavity by a gripping device and aligned in the fixing position. The alignment in the fixing position can take place both in the axial direction in relation to the longitudinal axis of the base body and/or in the radial direction. In the radial direction, an alignment is particularly provided when the contact surface is provided only sectionally in the peripheral direction on the outer periphery and/or when functional elements are already introduced into the filling body, which require a special alignment in relation to the hollow body.

The gripping device is preferably formed as a vacuum gripper or magnetic gripper. Alternatively, the sections formed on the filling body between the contact surfaces, in particular flattened portions or indentations, can be formed as gripping surfaces on which a gripping element can engage in a frictional or form-fitting manner.

After the introduction and fixing of the at least one filling body in the base body, the rotationally symmetrical hollow body can be processed by further steps. For example, an outer peripheral surface of the base body is processed, such as by twisting the outer peripheral surface. As a result, the at least one embossing point can also be removed. In any case, the at least one embossing point does not impair the post-processing. Even when the embossing point is to be removed by a post-processing of the outer periphery of the base body, this does not influence the clamping between an inner wall of the base body and the filling body. Furthermore, a processing can take place in the functional region of the hollow body, such as the introduction of a bore or the insertion of further construction components and/or functional parts in the filling body, for example.

The invention and further advantageous embodiment and developments thereof are described and explained in more detail below using the examples depicted in the drawings. The features that can be seen in the description and the drawings can be applied according to the invention individually or in several combinations. Here are shown:

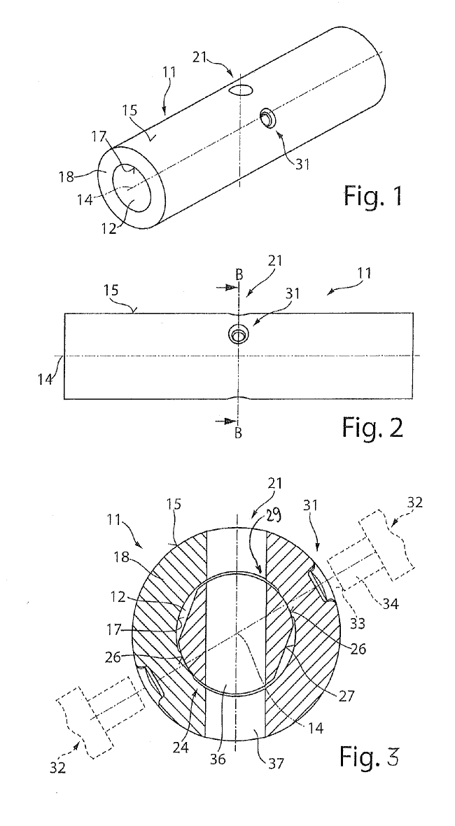

FIG. 1 a perspective view of a rotationally symmetrical hollow body according to the invention,

FIG. 2 a schematic side view of the hollow body according to FIG. 1,

FIG. 3 a schematic sectional view along the line B-B in FIG. 2,

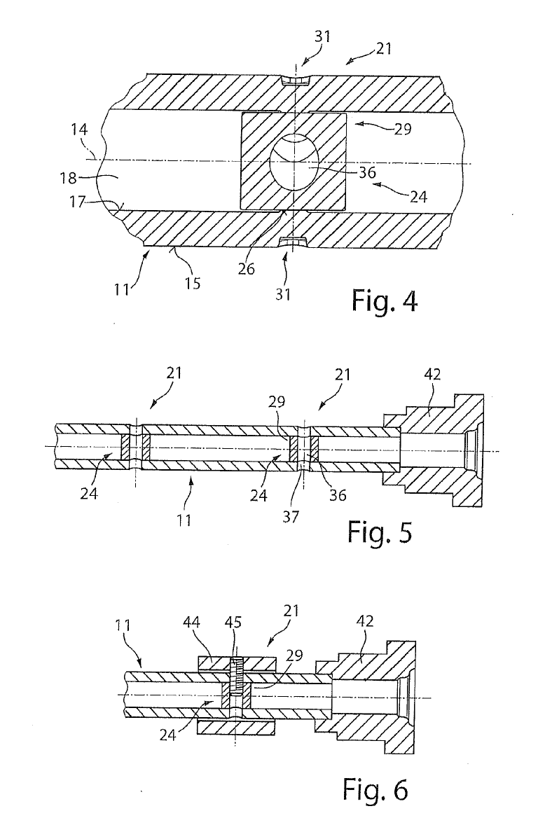

FIG. 4 a schematic longitudinal section of the hollow body having a filling body arranged therein,

FIG. 5 a schematic longitudinal section of a first application example, and

FIG. 6 a schematic longitudinal section of an alternative application example to FIG. 5.

A perspective view of a rotationally symmetrical hollow body 11 is depicted in FIG. 1. This rotationally symmetrical hollow body 11 comprises a base body 18 having at least one cavity 12, which extends along a longitudinal axis 14 of the base body 18. Preferably, the cavity 12 extends along the whole base body 18. The base body 18 comprises an outer peripheral surface 15 and an inner wall 17, by means of the spacing of which the thickness of a wall of the base body 18 is formed. The inner wall 17 borders the volume of the cavity 12 radially outwardly. In the exemplary embodiment, the rotationally symmetrical hollow body 11 is formed as a hollow cylinder. Further geometric cross-sections, which are preferably formed rotationally symmetrically, such as a square, hexagonal or octagonal cross-section or similar, for example, as well as a triangular cross-section in the shape of an equilateral triangle, are also conceivable.

The hollow body 11 comprises, for example, a functional region 21. This functional region 21 exemplarily has a bore according to the embodiment in FIG. 1.

A schematic side view of the hollow body 11 according to FIG. 1 is depicted in FIG. 2. The functional region 21 of the hollow body 11 is made obvious by a sectional view along the line B-B according to FIG. 2 in FIG. 3. In FIG. 4, a longitudinal section of the hollow body 11 according to FIG. 1 is depicted, from which the functional region 21 is also obvious.

A filling body 24 is inserted into the base body 18 for forming the functional region 21. This filling body 24 has a radial outer periphery, which comprises at least one contact surface 26. In the exemplary embodiment, two opposing contact surfaces 26 are formed. The contour of the contact surface 26 advantageously corresponds in the radial direction to a contour of the inner wall 17. A flattened portion 27 or an indentation or similar can be formed between the contact surfaces 62.

The at least one contact surface 26 of the filling body 24, said contact surface 26 extending sectionally in the radial direction, can advantageously extend completely along the length of the filling body 24, such as emerges from FIG. 4, for example, but extends at least along the region of the clamping.

The contact surface 26 can as long as it extends in the axial and radial direction be formed as a continuous surface. The contact surface 26 can also be formed as a corrugated or rippled surface or have other surface contours, which form an increased roughness.

A clamp is provided between the base body 18 and the filling body 24 for fixing the filling body 24 in a fixing position 29 to form the functional region 21. The clamp acts between the at least one contact surface 26 of the filling body 24 and a section of the inner wall 17 of the cavity 12. Thus, an inner clamp is formed between the filling body 24 and the base body 18, said clamp being independent of a contour or a progressive form of the outer peripheral surface 15 of the base body 18. Additional fastening elements are not required to form the inner clamp. The clamp is formed by at least one linear or planar pressure between the at least one section of the inner wall 17 of the cavity 12 and the contact surface of the filling body 24. A wall section of the base body 18 is preferably pressed radially in the direction of the filling body 24, in order to achieve the clamp with the filling body 24, in particular the at least one contact surface 26.

According to a preferred embodiment, the clamp is achieved by the introduction of at least one embossing point 31. Here, it is provided that the peripheral surface 15 of the base body 12 is impacted on radially from the outside with an embossing tool 32 depicted schematically and by a dashed line, in order to achieve a deformation by means of an embossing surface 33 of an embossing stamp 34, to the effect that the wall of the base body 18 is partially pressed inwards in order to clampingly abut on the filling body 24. Preferably, two sectionally formed contact surfaces 26 of the filling body 24 are formed in the region of the embossing points 31 that are preferably opposite one another, such that there is a sufficient clamping for fixing the filling body 24 in the functional region 21.

The deformation of the wall of the base body 18 preferably takes place only in the region of the embossing surface 33 of the embossing stamp 34, as emerges from the full cross-section according to FIG. 4 and in the longitudinal section according to FIG. 4. After the introduction of the embossing point 31, this can serve as a recess in the peripheral surface 15 of the base body 18.

The outer periphery of the at least two contact surfaces 26 of the filling body 24 is smaller than the diameter of the inner wall 17 of the cavity 12. Preferably, the diameter of the inner wall 17 to the outer periphery of the filling body 24 is measured by a transition fit or clearance fit, such that the clamping already takes place with a minimal deformation of the wall of the base body 18.

With the filling body 24 shown in the exemplary embodiment, a bore 36 is arranged in the filling body 24, said bore 36 sitting flush with a through-bore 37 of the hollow body 11. According to a first embodiment, it can be provided that the bore 36 and the through-bore 37 are each introduced separately, before the filling body 24 is inserted into the base body 18. However, preferably, the filling body 24 is transferred into the fixing position 29 in the base body 18, clamped and then introduced in a work process together with a flush bore 36 for the through bore 37.

One embossing point 31 can also suffice, deviating from in the exemplary embodiment depicted in FIGS. 3 and 4. Alternatively, several embossing points 31 can be formed in a radial plane in relation to the filling body. Alternatively, several embossing points 31 can also be formed in an axial direction. These embossing points 31 can be provided along a common axis in parallel to the longitudinal axis 14 or also offset with respect to each other.

The length of the filling body 24 when seen along the longitudinal axis 14 of the hollow body is advantageously smaller than the length of the base body 18 by a multiple. The length of the filling body 24 along the longitudinal axis 14 preferably extends at least by the length of the embossing point 31 extending in the direction of the longitudinal axis 14. Primarily, the length of the filling body 24 is formed by the functional region 21. If a bore is introduced, the size of the bore determines the length of the filling body 24, such that a sufficient wall strength is still provided adjacently.

The at least one contact surface 26 can be constant across the entire length of the filling body 24 in the axial extension. Alternatively, the contact surface 26 can also extend only along the embossing point 31, seen in the longitudinal direction, with respect to the length of the contact surface 26.

A schematic longitudinal section of the hollow body 11 according to FIG. 1 is depicted in FIG. 5, wherein a flange 42, for example, can be arranged on a front face side. It emerges from the schematic sectional view of the hollow body 11 that one, two or more filling bodies 24 can be inserted along the length of the hollow body 11, in order to respectively form a functional region 21. The functional region 21 comprises, for example, a through bore. The flange 42 can be pressed on, welded on or connected by a screw fastening on a front face end of the base body 18 to receive or to drive the hollow body 11, for example as a drive shaft, rotational shaft or similar. A drive element, for example a drive wheel, can be formed, pressed or fastened to this flange 42. This flange 42 can also only serve only as a mounting point, in particular radial mount, and can preferably comprise a sliding bearing or rolling bearing.

A further application case of the rotationally symmetrical hollow body to FIG. 5 is depicted in FIG. 6. The functional region 21 can be formed to the effect that a subassembly 44, such as an adjustment or abutment ring, a bushing or a sleeve, for example, is allocated to the outer peripheral surface 15. The subassembly 44 can be fixed, in particular releasably fixed, to the functional region 21 by a connection element 45. In the application case in FIG. 6, it is provided that the subassembly 44 is formed as a ring, for example, which is fixedly connected to the filling body 24 by a connection element 45 formed as a threaded pin. This subassembly 44 is thus fixedly allocated to the functional region 21. This subassembly 44 can also be re-removed by, for example, the introduction of a releasable connection element 45. Alternatively, it can also be provided that an unreleasable connection element 45 is introduced instead of a releasable connection element 45, for example a dowel pin or a rivet, in order to unreleasably fix such subassemblies 44 to the functional region.

Furthermore, it can be provided that the subassembly/subassemblies 44 can be shifted along the longitudinal axis 14, for example, and can also be held in a latched position. To do so, two balls mounted by a spring are provided, for example, in the filling body 24, which each engage on recesses of the sleeve pointing radially inwards to the functional region 21. As a result, a releasable latch connection can be created between the balls and the sleeve in order to be able to also shift the sleeve from a latch position into a further position in the axial direction along the longitudinal axis 14. Alternatively to the arrangement of a spring mounted between balls to form a releasable latch connection, a threaded insert having a spring-loaded latching ball can also be introduced on one or both sides in the functional region 21.

The arrangement of the releasable latch connection is only exemplary. The functional region 21 can complementarily be formed with further elements, components or similar in order to fulfil additional functions. Pins can be provided instead of the balls 47. Alternatively, threaded inserts can also be introduced, which receive a spring-mounted ball.

“Rotationally symmetrical hollow bodies” are to be understood as rotating shafts, drives or similar, which have at least one imbalance and/or have a symmetrical and/or asymmetrical course at least partially along the longitudinal axis.

1. A rotationally symmetrical hollow body having a base body and a cavity extending along a longitudinal axis of the base body, said cavity being limited by an inner wall of the base body, wherein at least one filling body is inserted into the cavity, the longitudinal extension of said filling body being shorter than the length of the base body in the axial direction in relation to the longitudinal axis of the base body, and the filling body is fixed in relation to the base body in a fixing position by at least one clamp acting between the filling body and the base body, and a functional region is formed in the base body by the filling body.

2. The hollow body according to claim 1, wherein the filling body has an outer periphery having at least one contact surface, which extends at least sectionally in the peripheral direction of the contour of the inner wall, and the outer periphery of the filling body is formed to be smaller than the inner periphery of the inner wall of the base body.

3. The hollow body according to claim 1, wherein the at least one contact surface of the filling body forming the outer periphery is calculated with a transition fit or clearance fit in relation to the inner periphery of the cavity.

4. The hollow body according to claim 1, wherein the clamp between the filling body and the base body is formed by at least one embossing point and one or more embossing points lying in one or more radial planes with respect to the longitudinal axis of the base body are introduced.

5. The hollow body according to claim 4, wherein the embossing point is formed with an embossing tool, said embossing point being applied radially from the outside on the base body.

6. The hollow body according to claim 4, wherein the at least one embossing point is introduced into the base body in the region of the filling body, in which base body the at least one sectionally formed contact surface of the filling body corresponds to the inner periphery of the cavity.

7. (canceled)

8. The hollow body according to claim 4, wherein the length of the filling body is at least greater than the longitudinal extension of the embossing point of the longitudinal axis along the longitudinal axis of the base body.

9. The hollow body according to claim 8, wherein the length of the at least one contact surface on the outer periphery of the filling body, which extends in the radial direction, corresponds at least to the radial extension of the embossing point.

10. The hollow body according to claim 1, wherein the filling body has a flattened portion or indentation in the radial direction between the at least two contact surfaces formed sectionally on the outer periphery.

11. (canceled)

12. The hollow body according to claim 1, wherein the base body has a cylindrical inner wall, the diameter of which is the same across the whole length of the base body.

13. The hollow body according to claim 1, wherein a flange is provided on the front face end of the base body.

14. A method for producing a rotationally symmetrical hollow body having a base body, a cavity extending along the longitudinal axis of said base body,
in which a filling body is inserted into the cavity on the front face end of the base body,
in which the filling body is transferred into a fixing position axially along the longitudinal axis of the base body, and
in which the filling body arranged in the fixing position is formed with the base body by a clamp acting between the filling body and the base body, and a functional region is formed.

15. The method according to claim 14, wherein an outer periphery is formed on the filling body, said outer periphery at least sectionally comprising a contact surface in the radial direction, said contact surface being adjusted to a contour of the inner wall of the cavity, and the outer periphery of the filling body is formed to be smaller than the periphery of the inner wall of the cavity.

16. The method according to claim 14, wherein a radial clamp is preferably formed by a radial embossing point between the filling body and the base body.

17. The method according to claim 16, wherein an embossing tool is supplied radially from the outside onto the base body and is impressed in the region in which the filling body is arranged in the fixing position, such that the filling body is held in a clamped manner in the fixing position.

18. The method according to claim 16, wherein the embossing tool has at least one embossing stamp which introduces the at least one radial embossing point radially from the outside, and a section of the inner wall of the cavity is transferred to the at least one contact surface of the filling body for the clamping contact.

19. The method according to claim 16, wherein two or more embossing points opposite one another are introduced into the base body, preferably in a radial plane, and, preferably, the contact surface extending at least sectionally on the outer periphery of the filling body is aligned towards the embossing point.

20. The method according to claim 14, wherein the filling body is introduced into the cavity of the hollow body with a gripping device and aligned in the fixing position and, preferably, held in the fixing position until the clamp is introduced.

21. The method according to claim 20, wherein the filling body is held frictionally and/or positively with a suction cup, magnetic gripper or with a gripping element and is transferred into the fixing position in the hollow body.

22. The method according to claim 14, wherein the outer peripheral surface of the base body and/or the functional region are processed after introducing and fixing at least one filling body in the base body.

23. The hollow body according to claim 1, wherein the outer periphery of the filling body corresponds to the contour of the inner wall of the cavity.

24. The hollow body according to claim 13, wherein the filling body is provided integrally on the flange.
